(19) United States
(12) Patent Application Publication
(10) Pub. No.: US 2020/0089798 A1
(43) Pub. Date: Mar. 19, 2020

(54) High volume-velocity time series data ingestion, analysis and reporting method and system

(71) Applicants: Paul R Ganichot, Tampa, FL (US); Vineet Mehta, Herndon, VA (US); Jeejosh Balan, Windermere, FL (US); Sanjeev Verma, Orlando, FL (US)

(72) Inventors: Paul R Ganichot, Tampa, FL (US); Vineet Mehta, Herndon, VA (US); Jeejosh Balan, Windermere, FL (US); Sanjeev Verma, Orlando, FL (US)

(21) Appl. No.: 16/133,515

(22) Filed: Sep. 17, 2018

(51) Int. Cl. G06F 17/30; G06F 9/54

(52) U.S. Cl. CPC G06F 17/30551; G06F 17/30516; G06F 9/542; G06F 17/30595; G06F 17/30315; G06F 17/30563

(57) ABSTRACT

A computer-implemented time-series data processing method comprises receiving high volume-velocity time-series information from one or more data emission devices concerning the occurrences of events and a desired output to be generated. A data identification and structure scheme comprised of a set of identifiers, of a set of record keys and of a set of database tables is analyzed. The information concerning the occurrences of events and associated to the set of identifiers is received at a host computer that is one of one or more host computers configured to ingest and analyze the data. The computer-implemented method processes and stores the received data using the data identification and structure scheme. The computer-implemented method further processes the stored data to generate the desired output.

### BACKGROUND

A time series is a series of data points listed in time order. Thus, it is a sequence of discrete-time data where time is typically represented in the form of a timestamp. A time series consequently is comprised of pairs of characteristic dimensions data and a timestamp. Examples of characteristic dimensions time series are heights and temperature of ocean tides, counts of sunspots, and the daily closing value of the Dow Jones Industrial Average. Characteristic dimensions are sometimes also referred to as parameters, variables, or tag in the Internet of Things and automation domains. Characteristic dimension value change events are typically caused by a physical or virtual activity. Time series analysis comprises methods for analyzing time series data in order to extract meaningful statistics and other characteristics of the data. In many situations, in order to allow analysis to occur, it is desirable to collect the time-series data generated by a system of interest and store the data in a data store.

Devices that generate, emit, or transmit time series data including computers, Internet of Things “things”, sensors, and gateways are referred to as data emission devices or data sources. Very large amounts of data emitted, received, transmitted, or processed in a short amount of time is referred to as high volume-velocity data. The persistent storage of data in computer-implemented method is referred to as data storage while the physical construct where said data storage is performed is referred to as data store. A key-value database, or key-value store, is a data storage paradigm designed for storing, retrieving, and managing associative arrays, a data structure more commonly known today as a dictionary or hash table. Dictionaries contain a collection of objects, or records, which in turn have many different fields within them, each containing data. Each record in a key-value database table is stored and retrieved using a key, or a combined key, that uniquely identifies the record, and is used to quickly find the data within the table. A relational database is a data storage paradigm based on the relational model of data, as proposed by E. F. Codd in 1970. Each record in a relational database table has its own unique key. Rows in a relational database table can be linked to rows in other relational database tables by adding a column for the unique key of the linked row (such columns are known as foreign keys).

Numerous methods and systems have been provided to meet the need for time series data collection and analysis. However, present methods and systems have often proven unable to appropriately meet the ingestion and reporting requirements in situations where there is high volume-velocity of time series data to be ingested and where reporting is required both from a temporal ordering perspective and from a characteristic dimension perspective. Accordingly, there is a need for improved methods and systems that are capable of meeting the ingestion and reporting requirements in the aforementioned situations.

### SUMMARY

This invention provides an improved method and system for the ingestion and reporting of high volume-velocity time series data. According to an exemplary embodiment, a computer-implemented data processing method comprises receiving time series data in large volume and in a short amount of time from one or more data emission devices concerning a desired output to be generated, processing the received data for identification and storage, and processing the stored data for the desired analysis and reporting output. The received data is identified by a set of three record keys and stored in a set of database key-value and key-value-document tables using combinations of said set of three record keys. The set of three record keys comprises a source group identifier grouping the data emission devices according to a desired output to be generated, a source identifier uniquely identifying a data emission device within a source group, and a timestamp providing temporal ordering. Storage processing of the received data comprises assigning the source identifier key and the timestamp key as the combined record key uniquely identifying each record in the key-value table and assigning the group identifier key and the source identifier key as the combined record key uniquely identifying each record in the key-value-document table. Analysis and reporting processing comprises retrieving from the key-value-document table the desired list of records using a combination of group identifier keys and source identifier keys based on specified parametric values and retrieving from the key-value table the list of records corresponding to the aforementioned key-value-document table desired list of records using the same source identifier keys and a specified temporal section.

According to another exemplary embodiment, a computer-implemented data processing method comprises receiving time series data in large volume and in a short amount of time from one or more data emission devices concerning a desired output to be generated, processing the received data for identification and storage, and processing the stored data for the desired analysis and reporting output. The received data is identified by one or more sets of three record keys and stored in one or more sets of database key-value and key-value-document tables using combinations of said sets of three record keys. Each said set of three record keys comprises a source group identifier grouping the data emission devices according to a desired output to be generated, a source identifier uniquely identifying a data emission device within a source group, and a timestamp providing temporal ordering. Storage processing of the received data comprises assigning one of the plurality of the source identifier keys and the timestamp keys as the combined record key uniquely identifying each record in one of the plurality of the key-value tables and assigning one of the plurality of the group identifier keys and one of the plurality of the source identifier keys as the combined record key uniquely identifying each record in one of the plurality of the key-value-document tables. Analysis and reporting processing comprises retrieving from one or more the key-value-document tables the desired list of records using a combination of from one or more group identifier keys and from one or more source identifier keys based on specified parametric values and retrieving from one or more the key-value tables the list of records corresponding to the aforementioned key-value-document tables desired list of records using the same from one or more source identifier keys and a from one or more specified temporal sections.

While the invention has been described in detail with specific reference to preferred embodiments thereof, it is understood that variations and modifications thereof may be made without departing from the spirit and scope of the invention.

### BRIEF DESCRIPTION OF THE DRAWINGS

FIG. 1 is a diagram of the relationships between a set of three identifiers and a set of three record keys in some embodiments.

FIG. 2 is a diagram of a set of Key-Value and Key-Value-Document tables in some embodiments.

FIG. 3 is a diagram of a set of Relational Database tables in some embodiments.

FIG. 4 is a diagram of the reception and ingestion processing of time-series in some embodiments.

FIG. 5 is a diagram of multiple sets of Key-Value, Key-Value-Document, and Relational Database tables in some embodiments.

FIG. 6 is a diagram of time-series and computed information retrieval and reporting processing in some embodiments.

FIG. 7 is a diagram of a set of key structure within a set of Key-Value and Key-Value-Document tables in some embodiments.

FIG. 8 is a diagram of a flow of time series data from data emission devices to receiving computers through to analysis and reporting computers with sets of record keys, sets of Key-Value, Key-Value-Document, and Relational Database tables, and sets of desired analysis and reporting outputs in some embodiments.

FIG. 9 is a diagram of the reception and ingestion processing of supplemental information in some embodiments.

### DETAILED DESCRIPTION

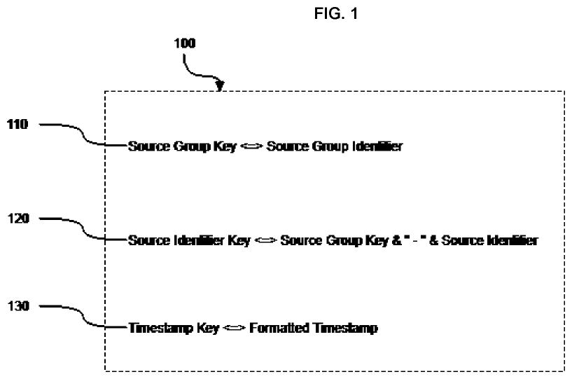

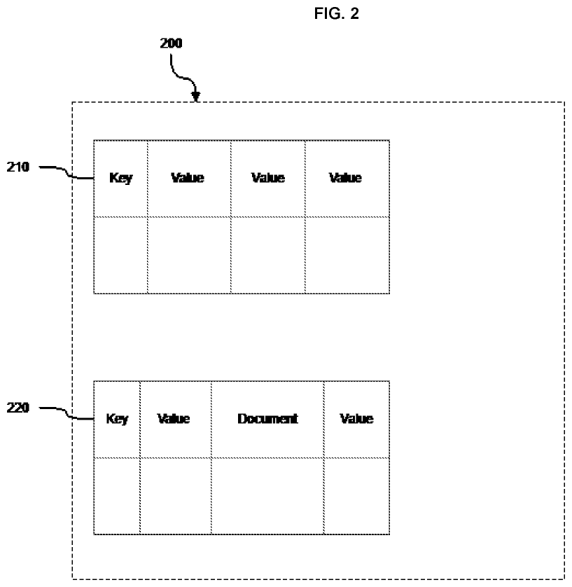

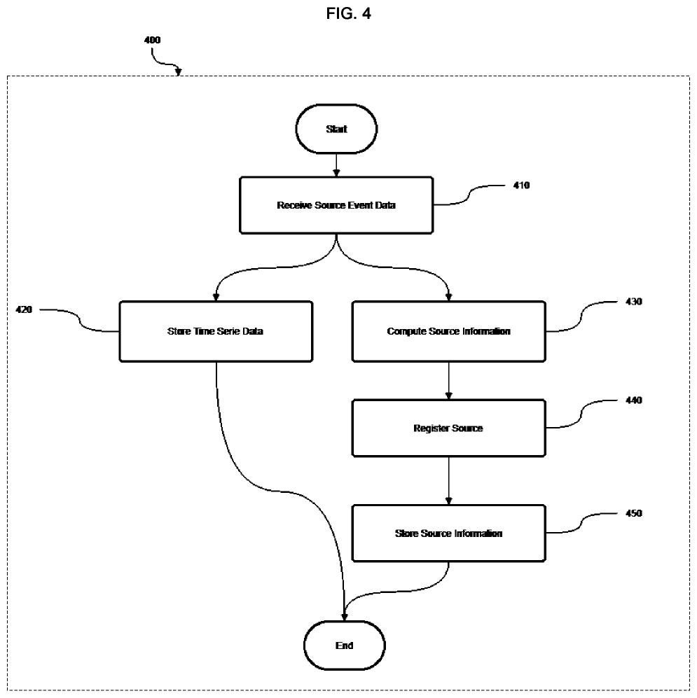

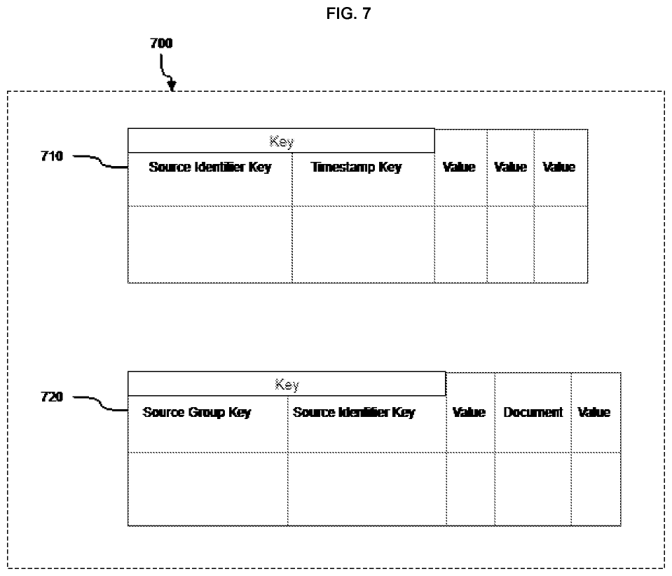

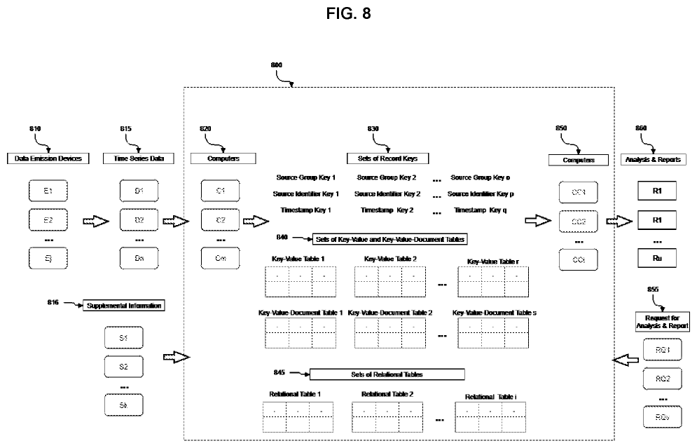

Methods and systems for high volume-velocity time series data ingestion and reporting are provided and various embodiments of said methods and systems are described. According to another exemplary embodiment, referring now to FIG. 8 a computer-implemented data processing system 800 comprises receiving time series data 815 in large volume and in a short amount of time from one or more data emission devices 810. Said computer-implemented data processing system comprises one or more computers 820 where each computer comprises at least one central processing unit (CPU), at least one random access memory unit, and access to at least one persistent storage unit. Said one or more computers component is depicted in FIG. 8 as containing the number “m” of instances where “m” represents an integer greater or equal to 1. The received time series data 815 comprises one or more pairs of characteristic dimensions data and timestamp. Said characteristic dimensions data comprises at least one characteristic dimension relevant to the desired output; examples of said characteristic dimensions are temperature, pressure, latitude, and longitude. Said one or more pairs of characteristic dimensions data and timestamp component is depicted in FIG. 8 as containing the number “n” of instances where “n” represents an integer greater or equal to 1. Said data emission devices 810 comprises one or more data emission devices where each data emission device is emitting time series data. Said one or more data emission devices component is depicted in FIG. 8 as containing the number “j” of instances where “j” represents an integer greater or equal to 1. The computer-implemented data processing system 820 processes the received time series data for identification using sets of three record keys 830 and for storage in sets of key-value and key-value-document tables 840. Said sets of three record keys 830 comprises one or more sets of three record keys where, as depicted in FIG. 1, each set of three record keys 100 comprises three record keys represented as 110, 120, and 130. Said one or more sets of three record keys component is depicted in FIG. 8 as containing the number “o”, “p”, and “q” of instances where “o”, “p”, and “q” represent integers greater or equal to 1. As depicted in FIG. 1, a set of three record keys comprises a Source Group Key 110 representing an identifier for a unique source group and a Source Identifier Key 120 representing an identifier for a unique data source. Accordingly, in this exemplary embodiment, said unique data source represents a unique data emission device 810 with a unique Source Identifier Key 120 within the computer-implemented data processing system 820. Similarly, in this exemplary embodiment, said unique source group represents a unique category of data emission devices 810 with a unique Source Group Key 110 within the computer-implemented data processing system 820. Said sets of key-value and key-value-document tables 840 comprises one or more sets of key-value and key-value-document tables depicted in FIG. 2 as 200 where each set comprises one or more key-value and key-value-document tables 210 and 220. Said one or more sets of key-value and key-value-document tables component is depicted in FIG. 8 as containing the number “r” and “s” of instances where “r” and “s” represent integers greater or equal to 1. Following the process flow 400 of FIG. 4, the process component 410 depicts the reception of time series data 815 by the computer-implemented data processing system 820. Process component 410 triggers two other process components 420 and 430 in separate threads. Process component 420 assigns the Source Identifier Key 120 and assigns the timestamp element of the received time series data 815 as the Timestamp Key 130. Subsequently, process component 420 stores the time series data 815 into the Key-Value table 210 using a combined key comprised of Source Identifier Key 120 and Timestamp Key 130 as depicted by 710 in FIG. 7. Each of the characteristic dimensions data element contained in each of the time series data 815 is stored as a separate Value column of the Key-Value table 210 for the same combined key comprised of Source Identifier Key 120 and Timestamp Key 130. As part of a separate processing thread executed by the one or more computers 820 and as depicted in 400, process component 430 analyzes the time series data 815 and generates the desired output corresponding to the received characteristic dimensions data in the key-value-document format required by the Key-Value-Document table 220. Subsequently, process component 440 optionally registers the source identifier corresponding to the Source Identifier Key 120 in the key-value-document table 220 if that source identifier was not previously registered in table 220. Subsequently, process component 450 stores the generated desired output corresponding to the received characteristic dimensions data into the Key-Value-Document table 220 using a combined key comprised of Source Group Key 110 and Source Identifier Key 120 as depicted by 720 in FIG. 7. Component 700 in FIG. 7 depicts the relationships between a set of three record keys comprised of Source Group Key, Source Identifier Key, and Timestamp Key with a Key-Value table and with Key-Value-Document table.

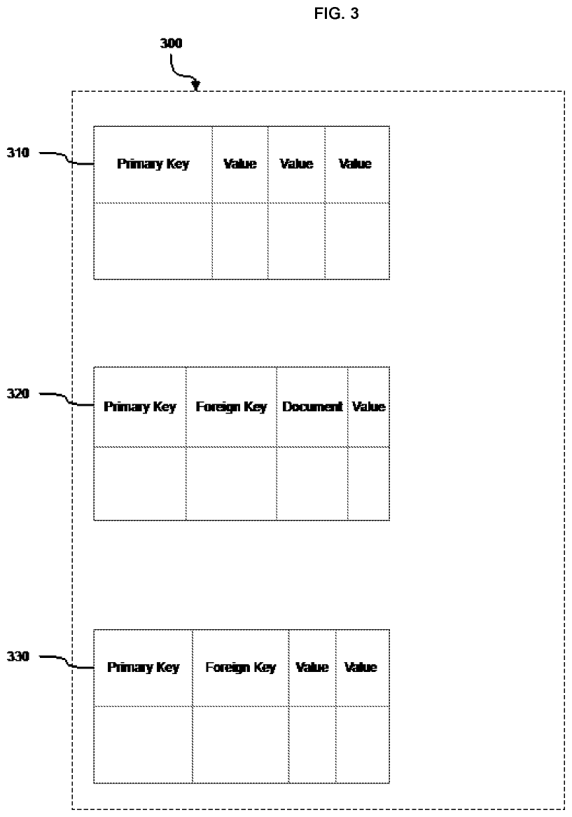

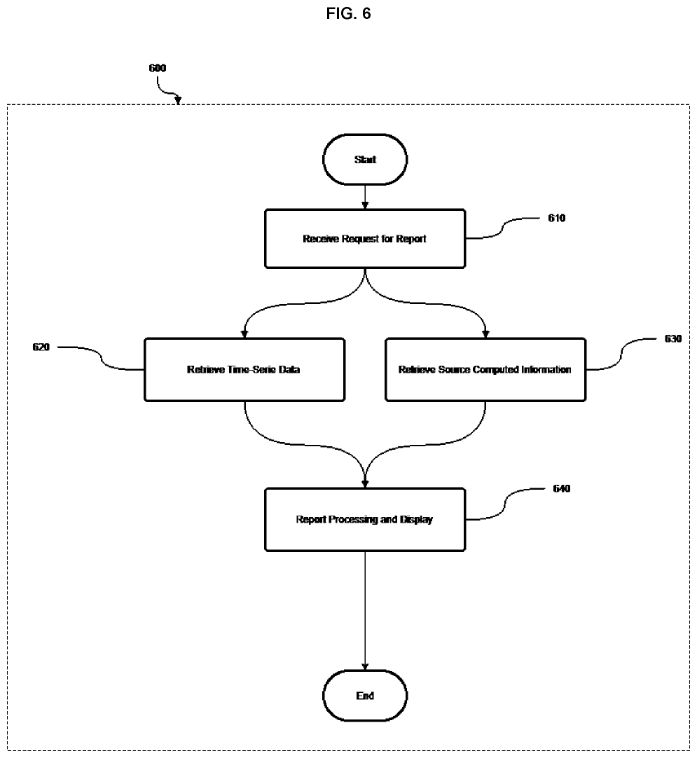

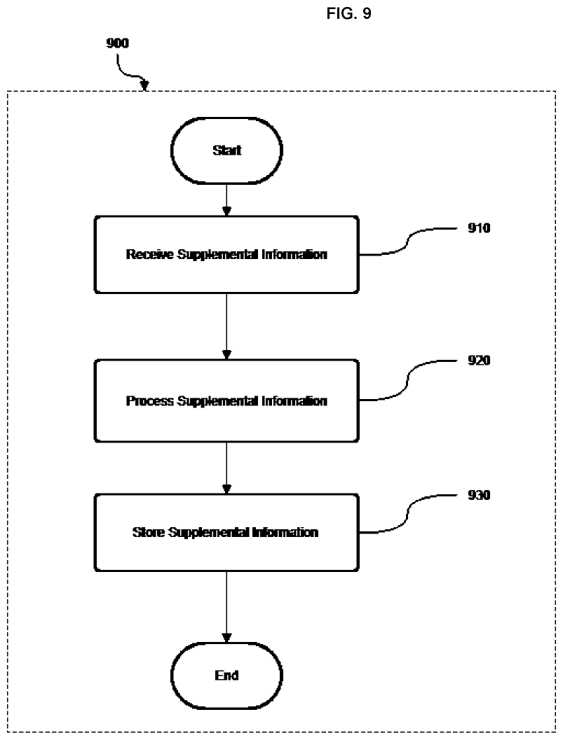

Information related to the generated desired output and corresponding to the received characteristic dimensions data contained in each of the time series data 815 is stored as a separate Value column or Document column of the Key-Value-Document table 220 for the same combined key comprised of Source Group Key 110 and Source Identifier Key 120. Referring now to FIG. 9, a process flow 900 to receive, process, and store supplemental information 816 represents the reception of attributes related to said source group or related to said data source by a computer-implemented data processing system 820; examples of said supplemental information are name, identifier, configuration, location, association, and manager. Said one or more supplemental information component is depicted in FIG. 8 as containing the number “k” of instances where “k” represents an integer greater or equal to 1. The process component 910 receives one or more information elements containing supplemental information for the Source Group, Source Identifier, and characteristic dimensions of the time series related to the desired output reports. The process component 910 analyzes the received supplemental information and extracts the corresponding Source Group, Source Identifier, characteristic dimensions, and temporal section elements and generates the corresponding one or more Source Group Keys 110, Source Identifier Keys 120. The process component 910 then triggers the process component 920 that processes the corresponding supplemental information related to the extracted one or more Source Group Keys 110, Source Identifier Keys 120 and characteristic dimensions. Referring now to FIG. 3, supplemental information corresponding to the Source Group, Source Identifier, and characteristic dimensions of the time series are stored in one or more Relational Database tables 300 using a scheme of primary keys only as represented in 310 or using a scheme of primary keys and foreign keys as represented in 320 and 330. Said one or more Relational Database tables component 845 is depicted in FIG. 8 as containing the number “i” of instances where “i” represents an integer greater or equal to 1. Said Relational Database table schemes use the Source Group Keys 110, Source Identifier Keys 120 and characteristic dimensions to store the supplemental information corresponding to these Source Group Keys 110, Source Identifier Keys 120 and characteristic dimensions. Accordingly, process component 920 analyzes the supplemental information and retrieves the supplemental information that requires processing from the Relational Database tables 310, 320, and 330 corresponding to the Source Group Keys 110, Source Identifier Keys 120 and characteristic dimensions received in 910. Process component 920 executes the required processing of the supplemental information and then triggers process component 930. Process component 930 stores into the Relational Database tables 310, 320, and 330 the supplemental information processed by process component 920 using the corresponding the Source Group Keys 110, Source Identifier Keys 120 and characteristic dimensions. One or more requests for a desired output report 855 are received by a computer-implemented data processing system, referred to as 850 in FIG. 8, that comprises one or more computers where each computer comprises at least one central processing unit (CPU), at least one random access memory unit, and access to at least one persistent storage unit. Said one or more computers component is depicted in FIG. 8 as containing the number “t” of instances where “t” represents an integer greater or equal to 1. Said one or more requests for a desired output report component is depicted in FIG. 8 as containing the number “v” of instances where “v” represents an integer greater or equal to 1. Referring now to FIG. 6, an analysis and reporting process flow 600 is depicted where the process component 610 analyzes the received request for the desired one or more output reports and extracts the corresponding Source Group, Source Identifier, characteristic dimensions, and temporal section elements. The process component 610 generates the corresponding one or more Source Group Keys 110, Source Identifier Keys 120, and Timestamp Keys 130. Subsequently, Process component 610 triggers process components 620 and 630 in separate threads. Process component 620 retrieves from the Key-Value table 210 using the one or more Source Identifier Keys 120 and Timestamp Keys 130 corresponding to the Source Identifier, characteristic dimensions, and temporal section elements of the request received in 610. Process component 630 retrieves from the Key-Value-Document table 220 using the one or more Source Group Keys 110 and Source Identifier Keys 120 corresponding to the Source Group, Source Identifier, and characteristic dimensions, elements of the request received in 610. Process component 640 then aggregates the outputs of process components 620 and 630 and further refines said outputs to match the desired output of the request received in 610 and returns the aggregated one or more desired output reports 860. Said one or more desired output reports component is depicted in FIG. 8 as containing the number “u” of instances where “u” represents an integer greater or equal to 1.

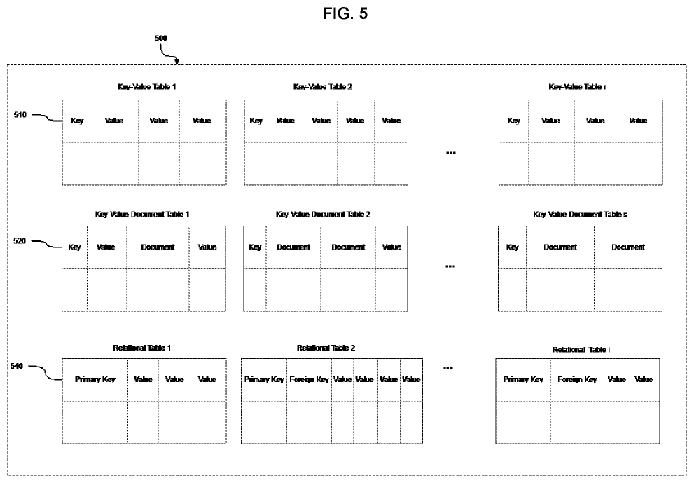

According to another exemplary embodiment, a method and system for high volume-velocity time series data ingestion and reporting as described above and where said sets of Key-Value and Key-Value-Document tables 840 and sets of one or more Relational Database tables 845 are further specified in FIG. 5 as 500. Said one or more Key-Value tables 510 component is depicted in FIG. 5 as containing the number “r” of instances where “r” represents an integer greater or equal to 1. Further, said one or more Key-Value tables 510 comprises tables with a varying number of value columns. Said one or more Key-Value-Document tables 520 component is depicted in FIG. 5 as containing the number “s” of instances where “s” represents an integer greater or equal to 1. Further, said one or more Key-Value-Document tables 520 comprises tables with a varying number of value and of document columns. Said one or more Relational Database tables 540 component is depicted in FIG. 5 as containing the number “i” of instances where “i” represents an integer greater or equal to 1. Further, said one or more Relational Database tables 540 comprises tables with a varying number of foreign key and of value columns.

According to another exemplary embodiment, a method and system for high volume-velocity time series data ingestion and reporting as described above and where said data emission devices 810 also transmit their respective supplemental information 816 comprising their respective source attributes and source group attributes to a computer-implemented data processing system 820.

Although the invention has been described and illustrated in the foregoing illustrative implementations, it is understood that the present disclosed subject matter has been made only by way of example, and that numerous changes in the details of implementation of the invention can be made without departing from the spirit and scope of the invention, which is limited only by the claims which follow.

What is claimed is:

1. A computer-implemented method for high volume-velocity time-series data ingestion and reporting, the method comprising:
a. at least one set of three identifiers:
i. Source Group Identifier
ii. Data Source Identifier
iii. Timestamp Identifier
b. at least one set of three record keys:
i. Source Group Key
ii. Source Identifier Key
iii. Timestamp Key
where said Source Group Key is a unique identifier in said computer-implemented method for said Source Group Identifier; where said Source Identifier Key is comprised of a prefix made up of said Source Group Key and a suffix corresponding to said Data Source Identifier so that said Source Identifier Key is a unique identifier in said computer-implemented method for said Data Source Identifier; where said Timestamp Key is a formatted representation of said Timestamp Identifier so that all Timestamp Keys have the same format in said computer-implemented method;
c. at least one Key-Value table, using a composite key of said Source Identifier Key and said Timestamp Key to uniquely identify each record;
d. at least one Key-Value-Document table, using a composite key comprised of said Source Group Key and said Source Identifier Key to uniquely identify each record;
e. receiving, at one or more computing devices, a plurality of time-series data events, each event element comprising a Data Source Identifier, a timestamp, and event data and being generated by a data source in response to a physical or virtual activity;
f. processing, using the one or more computing devices, the plurality of time-series data events to insert the time-series data events into said at least one Key-Value table using the Source Identifier Key and Timestamp Key and to insert or update the corresponding Source Identifier record into said at least one Key-Value-Document table with the time-series data event using said Source Identifier Key and said Source Group Key.

2. The computer-implemented method of claim 1, wherein said Source Group Identifier, or said Data Source Identifier, or both are further specified with attributes stored in a set of Relational Database tables.

3. The computer-implemented method of claim 2, wherein said data sources transmit to said computer-implemented method said attributes for storage of said attributes in said set of Relational Database tables.

4. The computer-implemented method of claim 2, wherein desired analysis and reports are processed using one or more of:
a. at least one of said Key-Value-Document tables, any combination of at least one of said Source Group Keys, of said Source Identifier Keys, or of said Timestamp Keys, zero or more of said Relational Database tables, and zero or more of said attributes;
b. at least one of said Key-Value-Document tables, at least one of said Relational Database tables, and at least one of said attributes;
c. at least one of said Key-Value tables, at least one of said Timestamp Keys, any combination of at least one of said Source Group Keys or of said Source Identifier Keys, zero or more of said Relational Database tables, and zero or more of said attributes;
d. at least one of said Key-Value tables, at least one of said Relational Database tables, and at least one of said attributes.
